(19) United States
(12) Patent Application Publication
(10) Pub. No.: US 2026/0116787 A1
(43) Pub. Date: Apr. 30, 2026

(54) SYSTEMS AND METHODS FOR A MODULAR WATER CLEANING ROBOT

(71) Applicant: LACUUM, LLC, ANN ARBOR, MI (US)

(72) Inventors: Amer Abughaida, Ann Arbor, MI (US); Maani Ghaffari Jadidi, Ann Arbor, MI (US); Minghan Zhu, Ann Arbor, MI (US)

(21) Appl. No.: 19/373,445

(22) Filed: Oct. 29, 2025

Related U.S. Application Data
(60) Provisional application No. 63/713,859, filed on Oct. 30, 2024.

(51) Int. Cl. C02F 1/40; B25J 9/16; B25J 11/00; E02B 15/10

(52) U.S. Cl. CPC C02F 1/40; B25J 9/1679; B25J 9/1697; B25J 11/0085; E02B 15/105

(57) ABSTRACT

In some implementations, the cleaning robot may include receiving, via an external sensor, a surrounding environment status. In addition, the cleaning robot may include identifying, based on the surrounding environment status, a debris. The cleaning robot may include receiving a capability parameter associated with the cleaning robot. Moreover, the cleaning robot may include generating a plan for the cleaning robot to collect and dispose of the debris based on the capability parameter, the debris position, and the debris type. Further, the cleaning robot may include receiving, during the execution of the plan, an updated surrounding environment status. In addition, the cleaning robot may include determining, based on the updated surrounding environment status and the plan, a progress status. The cleaning robot may include determining, based on the progress status, an updated plan which increases a likelihood of success for collecting and disposing of the debris.

### TECHNICAL FIELD

The invention generally relates to managing the operations of one or more modular water-cleaning robots.

### BACKGROUND

Bodies of water, drain ditches, and beaches can become polluted with unwanted debris from various sources, including natural and artificial debris. Left unchecked, the accumulation of natural and artificial debris may decrease the navigability and aesthetic quality of a body of water. Further, debris such as invasive plants may overwhelm native plants and affect the local marine life, depriving them of oxygen, nutrients, and sunlight. Most options for cleaning bodies of water are labor intensive and require specialized equipment and specialized water fairing crafts. For example, invasive forms of water-based plant life may become a significant obstruction in a body of water where an individual must stand on the shore (or in a boat) and use specialized tools to cut and gather the plant life. Such measures may require regular reoccurrences to keep the debris under control.

### SUMMARY

It is an advantage of the present invention to provide regular cleaning of bodies of water without constant human supervision, labor, and intervention.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, the method may include receiving, via an external sensor, a surrounding environment status. The method may also include identifying, based on the surrounding environment status, debris, and, based on the debris, identifying a debris position and a debris type. The method may furthermore include receiving a capability parameter associated with the cleaning robot. The method may, in addition, include generating a plan for the cleaning robot to collect and dispose of the debris based on the capability parameter, the debris position, and the debris type. The method may moreover include executing the plan by the cleaning robot. The method may also include receiving an updated surrounding environment status during the execution of the plan. The method may furthermore include determining, based on the updated surrounding environment status and the plan, a progress status. The method may in addition include determining, based on the progress status, an updated plan which increases a likelihood of success for collecting and disposing of the debris. The method may moreover include executing, by the cleaning robot, the updated plan. Other embodiments of this aspect include corresponding computer systems, apparatus, and computer programs recorded on one or more computer storage devices, each configured to perform the actions of the methods.

### BRIEF DESCRIPTION OF THE DRAWINGS

Advantages of the present invention will be readily appreciated as the same becomes better understood by reference to the following detailed description when considered in connection with the accompanying drawings wherein:

FIGS. 1A-1C illustrates an example embodiment of the cleaning robot, according to the systems and methods described herein;

FIGS. 2A-2D illustrates an example embodiment of a trailer with and without the cleaning robot attached, according to the systems and methods described herein;

FIG. 3 illustrates an example computing environment in which the cleaning robot may operate, according to the systems and methods described herein;

FIG. 4 is a flowchart of an example process for operating the cleaning robot, according to the systems and methods described herein; and

FIG. 5 is a flowchart of an example process for refining a machine learning model associated with the cleaning robot, according to the systems and methods described herein.

### DETAILED DESCRIPTION

In some embodiments, the systems and methods described herein may be configured to utilize a modular uncrewed surface vessel (USV) as the cleaning robot which may clean the water surface from various debris and pollution objects. In some embodiments, the cleaning robot may be equipped with processes aimed for detecting debris, creating an optimized path for collecting and treating pollution, and applying a control algorithm for navigating the vessel around the body of water.

The systems and methods described herein may further utilize a suite of sensors, a transceiver, a processor, and an arrangement of actuators. In some embodiments, the systems and methods described herein may be configured to utilize a modular setup which allows various accessories to be installed on the cleaning robot. In some embodiments, the accessory may transfer data and energy between the accessory and the cleaning robot, and vice versa.

The systems and methods described herein may be configured to operate in polluted water bodies, infested with algal bloom, invasive plants, floating debris such as plastics, and oil spills which are an ever-increasing phenomenon due to human activities and global warming. In some embodiments, the systems and methods described herein may be configured to sweep and clean the entire lake which, if done manually, may be very time-consuming.

The systems and methods described herein may be configured to autonomously identify the polluted areas in the lake and differentiate between native plants and invasive plants. In some embodiments, the systems and methods described herein may be configured to identify an oil spill, algal bloom area, and floating debris such as macro and microplastics.

The systems and methods described herein may be configured to create a path that optimizes time and energy. In some embodiment, the systems and methods described herein may be configured to take into consideration weather disturbances such as wind, water current, waves, wakes, and other environmental effects. In some embodiments, the systems and methods described herein may further comprise compensating for estimated stops for debris disposal, recharging, and filling up with treatment fluid (e.g., herbicide, liquid fuel, fluoridone, glyphosate, imazapyr, diquat dibromide, etc.). Additionally, the systems and methods described herein may determine how the accessory may alter the path, trajectory, and range estimations.

The systems and methods described herein may generate a control path that takes into consideration the actuation capabilities available on the cleaning robot. For example, whether the cleaning robot comprises an under-actuated or fully-actuated system.

The systems and methods described herein may be equipped with an auto-trailer loading system that allows the vessel to recharge, empty its collected debris, and refill with any necessary fluids (i.e., materials) to complete the cleanup of any body of water. The systems and methods described herein may be configured to function in any environmental condition, including, but not limited to, limited-visibility conditions such as operating overnight.

In some embodiments, some combination of the systems and methods described herein may be configured to operate fully autonomously (i.e., under no supervision) in low visibility conditions. For example, the systems and methods described herein may be configured to operate overnight in busy channels or lakes.

The systems and methods described herein may be configured with two stages (i.e., perception for mapping and operation). In a first stage, an aerial robot carrying a suite of sensors may fly over the lake and generates a map which describes the lake perimeter, physical structures (e.g. docks, bridges, piers, etc.), plants, floating objects, and pollutants on the lake surface. In some embodiments, this map serves as the reference map for the cleaning robot to plan a path for the cleaning task. In a second stage, the systems and methods described herein may be configured to utilize onboard sensors to locate pollutants and static and dynamic obstacles nearby to fulfill the cleaning task and navigate safely.

In some embodiments, the systems and methods described herein may include segmentation and mapping. The systems and methods described herein may be configured to identify different classes (e.g., water surface, docks, plants, etc.) on the landscape. In some embodiments, the systems and methods described herein may be configured to utilize recent advances in visual foundation models to bring general-purpose image segmentation models (e.g., Segment Anything V2, FastSAM, or Grounding DINO combined with SAM), which can be used as the inference model directly or used to accelerate the data labeling. The systems and methods described herein may be configured to leverage existing drone segmentation datasets (e.g., Semantic Drone Dataset, VDD) to train or fine-tune the systems and methods described herein.

The systems and methods described herein may be configured to estimate the area of interest on the lake. In some embodiments, a suite of sensors may be used to detect the area, using perception sensors such as, but not limited to, cameras, lidars, radars, ultrasound, and other environmental awareness sensors. In some embodiments, the data may comprise a lake perimeter, a physical structures (e.g. docks), plants, floating objects on the lake surface, and scanning for submerged or partially submerged objects.

The systems and methods described herein may be configured to process data and compare against preexisting databases for analysis. In some embodiments, new data findings may be used for training/refining machine-learned models utilized by the systems and methods described herein and stored for future reference.

The systems and methods described herein may be configured to collect data from the sea level using the cleaning robot to collect the data or using an aerial robot (e.g. a drone) to create a top view of the lake.

The systems and methods described herein may be configured to create an optimized path to cover the affected area. For example, when spraying chemicals, the systems and methods described herein may consider the sprayer range when creating the path. In a further example, when mechanically harvesting invasive plants, the path may be more tightly spaced out, depending on the width of the equipment and whether an overlap is needed.

The systems and methods described herein may be configured to return to a base to refuel (recharge), dump the collected debris, and refill with the required treatment materials. The systems and methods described herein may be configured to utilize localization systems, such as GPS, differential GPS, and perception sensors (e.g., cameras, Lidar, and radars, BLUETOOTH beacons) to identify the trailer's location. The systems and methods described herein may be configured to compensate for the effect of weather when generating the path and required trajectory. The systems and methods described herein may be configured to utilize the onboard actuators to load the cleaning robot onto the trailer automatically.

The systems and methods described herein may be configured to utilize an over-the-air (OTA) connection system that allows the cleaning robot to upload the recorded data to a cloud server for further processing and storage. Additionally, the systems and methods described herein may be configured to receive the latest software updates for previously unconsidered challenges and obstacles. Additionally, the systems and methods described herein may generate a distress signal indicating the cleaning robot is stuck, run aground, run out of energy, or for any other reason that requires the operator to be notified. In some embodiments, OTA service occurs via a cellular network, WIFI, BLUETOOTH, or any other wireless connection. In some embodiments, the systems and methods described herein may be configured to utilize a wired connection to transfer said data and software upgrades.

In some embodiments, the systems and methods described herein may be configured to be controlled by a remote controller operated by a user.

The systems and methods described herein may be configured to operate in lakes, ponds, and other water bodies that may not have a dedicated ramp for launch. In some embodiments, the systems and methods described herein may utilize a customizable trailer (described in greater detail below) that enables the cleaning robot to be launched into an uneven beach or in bodies of water where the water level is lower than the land level. For example, the trailer may comprise rails that may slide relative to the base trailer and may pivot relative to the trailer in order to keep bunks at an ideal angle for the cleaning robot to dock on.

In some embodiments, the trailer may comprise a powered connection to charge the cleaning robot, a data connection to transfer data and software from and to the cleaning robot, a mechanism that allows the transfer of debris from the cleaning robot, and other mechanisms that allows the transfer of treatment materials to the cleaning robot.

The systems and methods described herein may be configured to utilize the required sensors, energy storage, and actuators needed for navigation, propulsion, and control of the cleaning robot. In some embodiments, the systems and methods described herein may be equipped with a universal slider for installing various equipment on the vessel (described in greater detail below), and a data connector that allows the cleaning robot to recognize and communicate with said accessory. In some embodiments, a power exchange connector may allow the cleaning robot to power the accessory or vice versa, where the accessory has an internal battery or power source that may transfer energy to the cleaning robot.

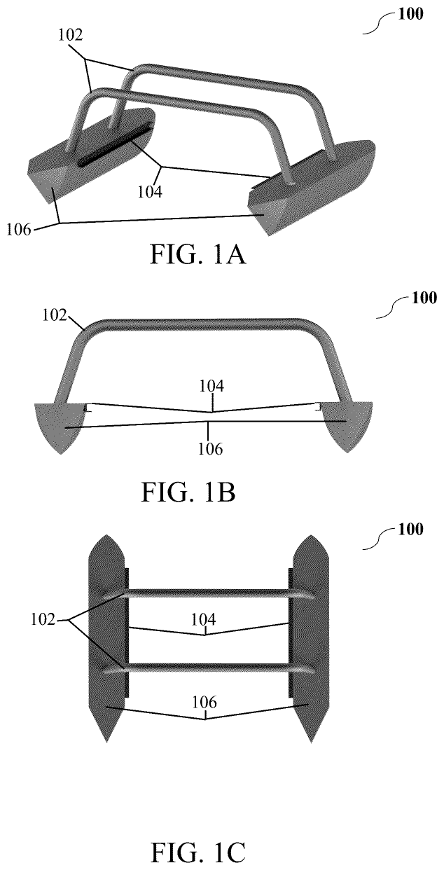

FIG. 1 illustrates an example embodiment of a cleaning robot 100 without any cleaning accessories attached. FIG. 1A is a perspective view of the cleaning robot 100, FIG. 1B is a front view of the cleaning robot 100, and FIG. 1C is a top-down view of the cleaning robot 100.

In some embodiments, the cleaning robot 100 may comprise two parallel hulls 106, which may be in contact with the water and may provide buoyancy and stability to the cleaning robot. In some embodiments, the hulls 106 may be connected via crossbars 102. The example embodiments of FIG. 1 illustrate two crossbars 102, but one crossbar or a plurality of crossbars may be used. In some embodiments, the crossbars 102 hold the hulls 106 in a parallel configuration.

In some embodiments, the cleaning robot 100 may further comprise an accessory port 104 for connecting accessories to the cleaning robot 100. In some embodiments, the cleaning robot 100 may install an accessory-to-accessory port 104 and create a communication and power connection. For example, the communication connection may be utilized to operate the accessory by the cleaning robot 100 and receive information from the accessory in relation to its operation and status. In a further example, the power connection may be utilized to provide power from the cleaning robot 100 for the operation of the accessory and to provide power from the accessory to the cleaning robot 100.

In some embodiments, the cleaning robot 100 may be may be provided with an amphibious locomotion system comprising two parallel Archimedes screws positioned longitudinally on the underside of the cleaning robot 100. In some embodiments, the pair of Archimedes screws may be independently actuated and configured to provide thrust and maneuverability across diverse environments. In some embodiments, for operation on water, the Archimedes screws may be rotated to generate forward thrust, enabling efficient and stable movement in the direction of the cleaning robot 100's primary axis. Conversely, when maneuvering on land, including beaches and mixed terrain, the unique helical geometry of the screws can be utilized to generate lateral forces. By rotating the two parallel screws in specific differential or synchronized manners, the cleaning robot 100 may be propelled in a sideways (i.e., crab walk) direction perpendicular to its primary axis, thereby facilitating high-precision positioning, obstacle avoidance, and simplified shoreline transitions without the need for complex wheel steering or reorientation mechanisms.

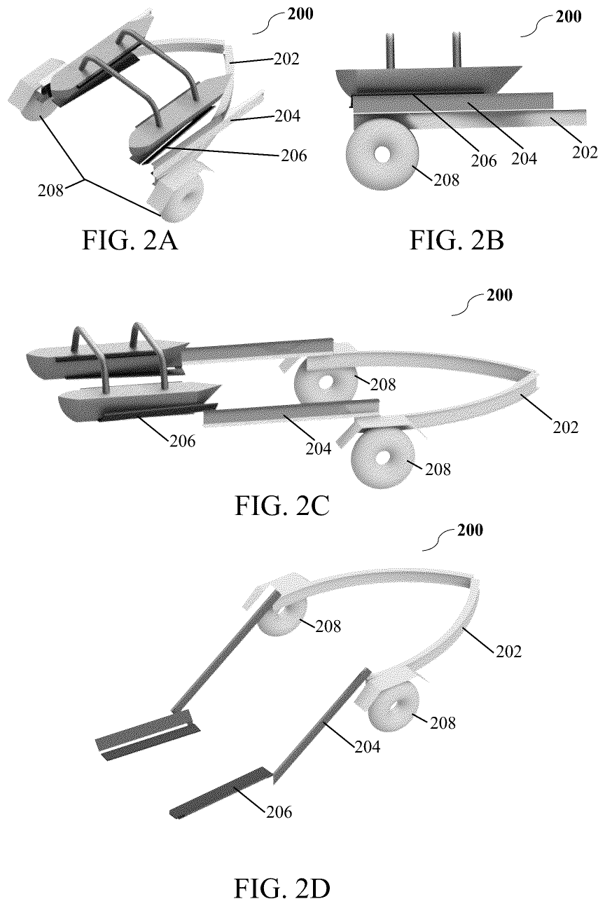

FIG. 2 illustrates an example embodiment of a trailer 200 loaded with and without the cleaning robot 100. FIG. 2A provides a top perspective view of the trailer 200 loaded with the cleaning robot 100. FIG. 2B provides a side view of the trailer 200 loaded with the cleaning robot 100. FIG. 2C provides a side perspective view of the trailer 200 at a partial extension and loaded with the cleaning robot 100. FIG. 2D provides a top perspective view of the trailer 200 at a full extension and without the cleaning robot 100.

In some embodiments, the trailer 200 may comprise a chassis 202, a rail 204, a bunk 206, and axle assembly 208. In some embodiments, the chassis 202 may be U-shaped, V-shaped, or a rounded V-shape. In some embodiments, the chassis 202 may provide structural support for the trailer 200. In some embodiments, the chassis 202 may comprise a computing device which communicates with the cleaning robot 100 and a battery to charge the cleaning robot 100. In some embodiments, the chassis 202 may be coupled to a wheel and axle assembly 208 to facilitate the trailer's maneuvering on land.

In some embodiments, the chassis 202 may be coupled to the rail 204, which may guide the cleaning robot 100 to the water, and the bunk 206, which holds the cleaning robot 100 when not in contact with the water. In some embodiments, the bunk 206 may communicatively couple to the cleaning robot 100 to charge/communicate. In some embodiments, the bunk 206 may further comprise the ability to unload debris cleaned from the cleaning robot 100. In some embodiments, the bunk 206 may facilitate the changing of accessories installed on the cleaning robot 100.

In some embodiments, the trailer 200 may be configured to assist with operations in lakes, ponds, and other water bodies that may not have a dedicated ramp for launch. In some embodiments, the trailer 200 may enable the cleaning robot 100 to be launched into an uneven beach or in bodies of water where the water level is lower than the land level. For example, the trailer 200 may utilize the rail 204 which may slide relative to the chassis 202 and may pivot relative to the trailer 200 to keep bunk 206 at an ideal angle for the cleaning robot 100 to dock to and from.

The systems and methods described herein may be configured to comprise the required sensors, energy storage, and actuators needed for navigation, propulsion, and control of the cleaning robot 100. In some embodiments, the systems and methods described herein may be equipped with a universal slider for installing various equipment on the vessel, and a data connector that allows the cleaning robot to recognize and communicate with said accessory. In some embodiments, a power exchange connector may enable the cleaning robot to power the accessory or vice versa, where the accessory has an internal battery or power source that may transfer energy to the cleaning robot 100.

In some embodiments, the auto trailer 200 may remain in a fixed position and may act as a GPS base station for the cleaning robot 100, utilizing a real-time kinematic (RTK) or similar differential correction methodology to achieve centimeter-level positioning accuracy. In some embodiments, the auto trailer 200 may be equipped with a high-gain GPS antenna that may continuously receive raw satellite data, calculate accurate positional corrections for localized atmospheric errors, and broadcast this correction data via the transceiver 355. In some embodiments, the cleaning robot 100 may act as the GPS Rover, incorporating an onboard high-precision GPS receiver and antenna capable of receiving both the raw satellite signals and the real-time correction data from the auto trailer 200. The robot's navigation 340 may process these combined data streams to compute the precise absolute position of the cleaning robot 100 which may enable efficient, systematic, and repeatable autonomous cleaning along predefined paths and ensure accurate homing and docking with the auto trailer 200.

In some embodiments, the trailer 200 may be configured to assist with accessory installations. For example, accessories may comprise a sprayer for spraying chemicals on algal blooms, mechanical harvesting equipment for cutting and collecting invasive plants, a large collective bucket for collecting floating debris, oil skimmers for oil spills, mapping and sampling equipment for scanning lake beds, collecting data on water health, collecting water samples for further investigation offline, and other customized equipment for future needs.

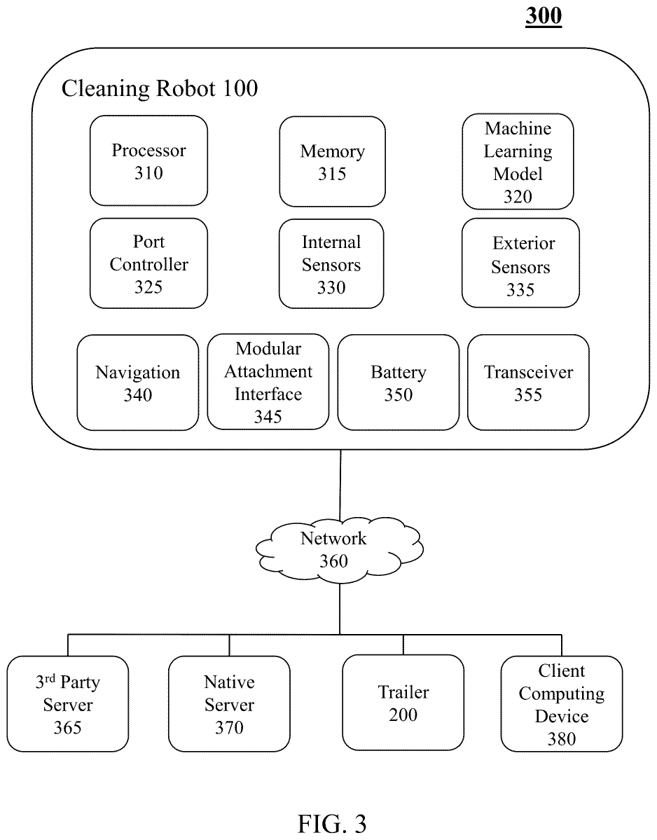

FIG. 3 illustrates an example computing environment 300 for operating the cleaning robot 100.

In some embodiments, the cleaning robot 100 may comprise a processor 310 and a memory 315. The processor 310 may comprise one or more computing cores, which may be configured to execute commands stored in memory. The memory 315 is a non-transitory computer-readable medium which may store computer instructions for execution by the processor 310. In some embodiments, the memory 315 may have stored thereon a prebuilt map of the body of water and surrounding area. In some embodiments, the prebuilt map may be obtained based on previous operations where the cleaning robot 100, in coordination with an aerial robot, surveys the area and generates a map, which may be stored for future use. In some embodiments, a library of prebuilt maps may be stored in the memory 315, the native server 370, the client computing device 375, the trailer 200, or some combination thereof. In some embodiments, the prebuilt map may be obtained from a 3^{rd} party mapping service.

In some embodiments, the cleaning robot 100 may comprise a machine learning model 320 having one or more pre-trained neural models. In some embodiments, the one or more pre-trained machine learning models may be stored locally in the memory 315, stored on a server for access over a network, or some combination thereof. In some embodiments, the machine learning model 320 may comprise a perception neural model for detecting and analyzing the exterior environment of the cleaning robot 100. In some embodiments, the machine learning model 320 may comprise a pathing neural model for determining the path the cleaning robot 100 may execute to most efficiently utilize the resources of the cleaning robot 100 while maximizing the amount of debris collected. In some embodiments, the progress of the cleaning robot 100 to execute the path generated by the pathing neural model is tracked based on the information collected by the perception neural model. In some embodiments, the progress information and the execution information are stored as training data for future refining of the machine learning model 320.

In some embodiments, the cleaning robot 100 may utilize either a neural model or a traditional model to compute optimal cleaning trajectories. In some embodimenst, when a neural model is employed, a deep reinforcement learning architecture, such as Deep Q-Networks (DQN) or Asynchronous Advantage Actor-Critic (A3C), may be used. These models may be trained to process real-time sensor inputs, including high-precision GPS data, sonar readings, and visual data, to generate a continuous sequence of optimal control actions, thereby efficiently covering the target cleaning area while avoiding static and dynamic obstacles. Alternatively, a traditional model may be implemented, such as a Dijkstra's algorithm, a Rapidly-exploring Random Tree (RRT or RRT), a Probabilistic Roadmap (PRM), or a Voronoi Diagram approach, wherein the cleaning path may be calculated by minimizing a cost function that considers factors such as energy consumption, debris density (mapped by sonar), and distance to the auto trailer 200.

In another embodiment, both a neural model and traditional approaches may be utilized. For example, the overall mission planning, such as defining large-scale cleaning sectors, may be handled by a traditional, graph-based model, while the immediate, local obstacle avoidance and path execution may be managed by a neural model for real-time responsiveness. In any of the above-described configurations, the calculated path may be continuously updated and executed by the robot's control module to ensure comprehensive and energy-efficient debris collection.

In some embodiments, the machine learning model 320 may be configured to also teach a robot to understand and leverage its internal motion data to improve performance. The cleaning robot 100 may collect proprioceptive sensory data, which includes information about its movements and positions. By feeding this data into a deep neural network, the cleaning robot 100 may learn specific inertial features unique to its own structure and behavior. These learned features help the machine learning model 320 approximate rewards more accurately, meaning better determination of how well the cleaning robot 100 is performing based on its current state.

The systems and methods described herein may use the Maximum Entropy Deep Inverse Reinforcement Learning (MEDIRL) algorithm. This approach helps the cleaning robot 100 learn the underlying reward structure from observed behaviors, even if those behaviors are not perfect. Additionally, minimizing a trajectory ranking loss, which may help the cleaning robot 100 deal with less-than-ideal demonstrations by ranking them and learning from the best ones. This dual approach may ensure that the cleaning robot 100 can effectively learn and improve its actions based on its own unique movements and the quality of the demonstrations it observes.

In some embodiment, the machine learning model 320 may be configured to use human movement data from a detailed ATC dataset to figure out the smallest safe distances, or “social zones,” that both humans and robots should keep from each other. In some embodiments, how people naturally move and interact is identified by these zones to ensure safety and comfort. In some embodiments, the social zones are programmed into the cleaning robot 100 navigation 340 using barrier functions, which are mathematical tools that help the cleaning robot 100 stay within safe boundaries. In some embodiments, the cleaning robot 100 navigates using these barrier functions to mimic human-like behaviors. For example, the cleaning robot 100 will pass on the right side of people, slow down, or even stop when in tight spaces, just like a human would. Tests and simulations show that this approach helps robots move in a way that feels natural and safe for the humans around them.

In some embodiments, the machine learning model 320 may be configured to understand and map out environments, despite much uncertainty. For example, the cleaning robot 100 may need to traverse a body of water with many obstacles. The cleaning robot 100 may need to know where and what they are in real-time. In some embodiments, the machine learning model 320 may be configured to combine two powerful approaches: traditional probabilistic algorithms (which are very reliable) and modern neural networks (known for their speed and efficiency).

In some embodiments, the machine learning model 320 may utilize an object detection approach to identify and localize marine debris or submerged obstacles within the sensor data (e.g., visual camera feeds and sonar images). The approaches employed may include specialized techniques like a Convolutional Bayesian Kernel Inference (ConvBKI) layer, or general-purpose foundation models such as Segment Anything Model (SAM) for generating high-quality segmentation masks. Other contemporary models may also be utilized, including Grounding DINO for zero-shot object detection combined with natural language prompting, and various one-stage object detection methods like the YOLO (You Only Look Once) family (e.g., YOLOv8, YOLO-NAS) for real-time performance. Additionally, two-stage object detection frameworks, such as Faster R-CNN or Mask R-CNN, may be employed for high-accuracy instance segmentation, or zero-shot object detection models like OWL-ViT may be used to identify novel objects not seen during training, thereby ensuring robust and adaptable detection across various marine environments.

In some embodiments, the machine learning model 320 may utilize a Convolutional Bayesian Kernel Inference (ConvBKI) layer. This layer may take visual information from the exterior sensors 335 and update a 3D map of the environment. The machine learning model 320 may generate educated guesses about what each part of the environment is, using both current observations and prior knowledge. The ConvBKI layer may use depth-wise convolution to process this information quickly and accurately, allowing the cleaning robot 100 to make real-time decisions about its surroundings.

In some embodiments, the cleaning robot 100 may be configured to utilize a dead reckoning in field time (DRIFT) framework designed to help the cleaning robot 100 understand its own movements and positions in real-time, using only onboard sensors. In some embodiments, the cleaning robot 100 may additionally utilize the GPS-DRIFT framework, a specific implementation of DRIFT which may perform robust marine surface robot localization by fusing data from the onboard Inertial Measurement sensor with high-precision GPS signals using an invariant filtering approach to maintain accurate positioning even during temporary GPS signal loss or high-sea state conditions. In some embodiments, the framework may utilize a mathematical filtering called invariant Kalman filtering, which makes the framework more accurate and reliable by preserving certain symmetrical properties of the movements of the cleaning robot 100. This approach may be made accessible through a didactic introduction, making it easier for a wide range of robotics applications to implement. The framework may rely on data from an onboard inertial measurement unit (IMU) and the movements of the cleaning robot 100 (kinematics) to estimate its state for dead reckoning, which is a technique for calculating the position of the cleaning robot 100 based on its previous position. Additionally, there are optional modules for estimating contact points and filtering gyro data, which are particularly useful. This may allow the cleaning robot 100 to track the state over long distances and time periods, even without external perception data like GPS or cameras, making it highly versatile.

In some embodiments, the machine learning model 320 may be configured to utilize a new error-state Model Predictive Control (MPC) approach that leverages connected matrix Lie groups to enhance the control of the cleaning robot 100 by focusing on the linearized tracking error dynamics and equations of motion derived within the Lie algebra framework. In some embodiments, the MPC approach ensures that the linearized tracking error dynamics and equations of motion remain globally valid and evolve independently of the trajectory, starting from any initial condition. This MPC technology may lead to more efficient and precise control of the cleaning robot 100, particularly in applications requiring robust and rapid adjustments in complex dynamic environments.

In some embodiments, the cleaning robot 100 may further comprise a port controller 325 for managing the input/output via a hardware connection. For example, the port controller 325 may be communicatively coupled to a standard information and power port such as, but not limited to, mini-USB, micro-USB, USB type-A, USB type-B, USB type-C, APPLE LIGHTING, FIREWIRE, or any appropriate form of wired communication/charging standard.

In some embodiments, the cleaning robot 100 may further comprise internal sensors 330 for capturing information relevant to the internal workings of the cleaning robot 100. In some embodiments, the internal sensors 330 may identify the relevant internal information of the cleaning robot such as, but not limited to, remaining battery, current power drain, propulsion status, accessory status, battery temperature, processor temperature, water intake, or any appropriate internal information associated with the cleaning robot 100. In some embodiments, the internal sensors 330 may comprise, but are not limited to, a thermometer, a voltage detector, an amplitude detector, a water sensor, a gyroscope, a proximity sensor, a contact sensor, a sound sensor, a gas sensor, an acceleration sensor, or any other appropriate sensor for capturing information related to the internal workings of the cleaning robot 100.

In some embodiments, the cleaning robot 100 may further comprise exterior sensors 335 for capturing information related to the external environment of the cleaning robot 100. In some embodiments, the exterior sensors 335 may identify the relevant external information of the cleaning robot such as, but not limited to, position, position relative to shore, position relative to trailer, angle relative to water's service, location of debris, external temperature, external atmospheric pressure, external wind speed/direction, water current, obstructions, weather, lighting conditions, and any other information related to the external environment of the cleaning robot 100. In some embodiments, the exterior sensors 335 may comprise, but are not limited to, a global positioning satellite (GPS) receiver, a gyroscope, a compass, an infrared sensor, one or more cameras, a light detection and ranging sensor (LIDAR), a radar, an ultrasonic sensor, one or more proximity sensors, a tactile sensor, a range sensor, a laser range finder, a temperature sensor, a gas sensor, a wind sensor, a rainfall sensor, a wind speed/direction sensor, and any appropriate sensor to collect information regarding the external environment of the cleaning robot 100.

In some embodiments, the cleaning robot 100 may include a navigation 340, which may allow the cleaning robot 100 to navigate the surface of a body of water. In some embodiments, the navigation 340 may comprise a jet drive, a fuel cell, a sterndrive, an outboard engine, a pod drive engine, a diesel engine, a liquified natural gas (LPG) engine, an inboard engine, a sail drive, a surface drive, archamedic screw, or any appropriate form of maritime propulsion. In some embodiments, the navigation 340 may further include a rudder or an adjustable angle for the drive of the propulsion. In some embodiments, the navigation 340 may comprise an actuator for altering the direction of propulsion via turning the rudder or the propulsion of the cleaning robot 100 or torque vectoring as appropriate for the chosen form of martime propulsion.

In some embodiments, the cleaning robot 100 may further include a modular attachment interface 345 for installing and controlling accessories for cleaning debris in combination with the accessory port 104. In some embodiments, the modular attachment interface 345 may comprise a physical locking mechanism and a contact point for attaching and equipping the accessory to the cleaning robot 100. In some embodiments, contact is made between the contact point on the accessory and a reciprocal contact point on the cleaning robot 100 to create a connection that allows power and communication to flow interchangeably between the accessory and cleaning robot 100. In some embodiments, the locking mechanism may comprise one or more manual or actuated latches, magnetic fasteners, plunger fasteners, lead thread fasteners, hook fasteners, and any other appropriate form of temporary maritime-compliant fastener. In some embodiments, the contact point may be a port such as, but not limited to, mini-USB, micro-USB, USB type-A, USB type-B, USB type-C, APPLE LIGHTING, FIREWIRE, or any appropriate form of wired communication/charging standard.

In some embodiments, the cleaning robot 100 may have installed a specialized front-mounted trimmer accessory, engineered for clearing aquatic and vegetative overgrowth (e.g., various fauna, invasive plant species, and large macroalgae mats), may be optionally attached to the front of the cleaning robot 100 via the modular attachment interface 345. In some embodiments, the trimmer may be configured with a horizontally oriented cutting blade or chain, positioned parallel to the water surface or the submerged seabed, to efficiently cut away dense growth. In some embodiments, the shearing force and added weight generated by the trimmer may require the temporary installation of an additional, deployable buoyancy support accessory (similar to a third pontoon or stabilizing leg) to the robot's underside. This support ensures the robot maintains pitch and roll stability during cutting operations and may also help regulate the trimmer's depth for optimal cutting effectiveness before the severed material is drawn into a refuse collection area in or on the cleaning robot 100. In some embodiments, positioned behind the trimmer may be a conveyor belt-style collector that collects the material cut by the trimmer and moves the material to a storage area on or in the cleaning robot 100.

In some embodiments, the cleaning robot 100 may also comprise a battery 350 for storing energy required to power the cleaning robot 100 and any accessories. In some embodiments, the battery may comprise a battery of lithium-ion, sealed lead acid, alkali, carbon zinc, lithium, zinc-air, silver oxide, solid state, or any appropriate form of energy storage. In some embodiments, the battery 350 may further comprise a fuel tank for a liquid fuel-powered embodiment and a range extension motor for hybrid embodiments.

In some embodiments, the cleaning robot 100 may further comprise a transceiver 355 for communicating wirelessly with a network or a computing device. In some embodiments, the transceiver 355 may utilize short-range and long-range communication standards. For example, the short-range communication standards may comprise BLUETOOTH, WIFI, near-field communication (NFC), ZIGBEE, Z-WAVE, ultra-wideband (UWB), and any other appropriate forms of short-range communication. In some embodiments, the long-range communication standards may comprise radio signals, cellular signals (e.g., CDMA, GSM, LTE, 2G, 3G, 4G, 5G, etc.), satellite signals, microwave signals, and any other appropriate forms of long-range communication.

In some embodiments, the cleaning robot 100 may utilize the transceiver 355 to connect to a network 360 (e.g., the internet). In some embodiments, the cleaning robot 100 may utilize a connection to the network 360 to send/receive information from 3^{rd} party server(s) 365. In some embodiments, 3^{rd} party server(s) 365 may comprise weather forecasting services, tide tracking services, day/night tracking services, water level tracking services, geographic mapping services, and any other service that provides information relevant to a body of water.

In some embodiments, the cleaning robot 100 may utilize a connection to the network 360 to send/receive information from a native server(s) 370. In some embodiments the native server(s) 370 may host a software platform developed for assisting in the operation of the cleaning robot 100. In some embodiments, the native server(s) 370 may comprise machine learning models with greater capacity than those accessible locally on the cleaning robot 100. In some embodiments, specific machine learning tasks may be offloaded to the native server(s) 370.

In some embodiments, the cleaning robot 100 may utilize a connection to the network 360 to send/receive information from a client computing device 375. In some embodiments, the client computing device 375 may have a native application specifically for controlling parameters related to the cleaning robot 100. For example, the user may, via the client computing device 375, view information related to the cleaning robot 100, such as remaining battery, cleaning status, accessory status, self-diagnostics, current speed, current location, current environmental conditions, location of trailer 200, and any other appropriate information related to the operation of the cleaning robot 100. In some embodiments, the client computing device 375 facilitates the user's input in human-in-the-loop machine learning operations. For example, the perception machine learning model may determine specific types of debris and prioritize their cleaning up; a user may review the targeting of debris and alter the prioritization based on the user's needs before or during the cleaning robot 100 operation. In some embodiments, the pathing machine learning model may create a path for cleaning debris which the user may alter or update based on the user's needs/desires.

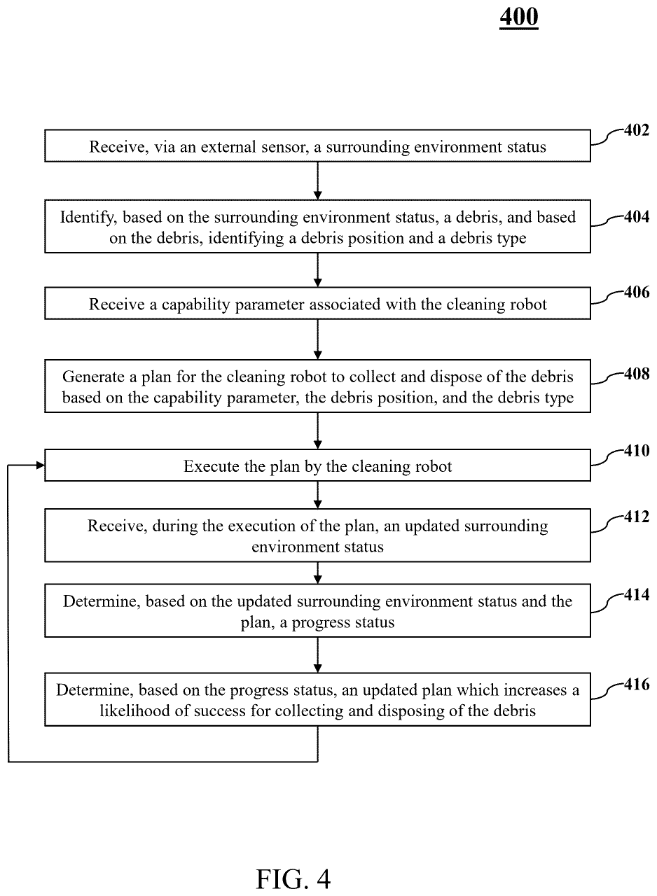

FIG. 4 is a flowchart of an example process 400 for operating the cleaning robot 100. In some implementations, one or more process blocks of FIG. 4 may be performed by the processor 310.

As shown in FIG. 4, process 400 may include receiving, via an external sensor, a surrounding environment status (block 402). For example, the exterior sensor(s) 335 may collect information related to the surrounding environment of the cleaning robot 100 such as, but not limited to, lighting conditions, weather conditions, atmospheric conditions, position relative to the shore, position relative to the trailer 200, water level, position of debris, type of debris, position of obstacles, types of obstacles, parameters of the body of water, and any other information related to the surrounding environment of the cleaning robot 100.

In some embodiments, the process 400 may load a prebuilt map from the memory 315 or from a 3^{rd} party mapping service. The prebuilt map may serve as a starting point for mapping the surrounding environment of the cleaning robot 100. In some embodiments, the processor 310 may generate updates to the prebuilt map based on information received from the external sensors 335 and the aerial robot.

In some embodiments, the aerial robot may be deployed to receive further information about the surrounding environment. The aerial robot may utilize onboard sensors to capture further information about the surrounding environment comprising one or more LiDARs, accelerometers, GPSs, inertial measurement sensors, barometers, cameras, thermal sensors, microphones, gyroscopes, depth sensors, and any other sensors which can gather information related to the surrounding environment.

As also shown in FIG. 4, process 400 may include identifying, based on the surrounding environment status, a debris, and based on the debris, identifying a debris position and a debris type (block 404). For example, the processor 310 may receive, via exterior sensors 335, information regarding the surrounding environment status, a debris, and based on the debris, identify a debris position and a debris type, as described above. In some embodiments, the processor 310 may transmit the relevant information to the machine learning model 320, which may have a perception neural model to interpret the information and generate a spatial map of the surroundings of the cleaning robot 100, which may include the surrounding environment status, a debris, and based on the debris, identify a debris position and a debris type. In some embodiments, the perception neural model updates in real-time as updated information regarding the surrounding environment is received by the exterior sensors 335 and the aerial robot. In some embodiments, debris may comprise common targets for remediation in, on, and around bodies of water including plastics and Styrofoam (e.g., plastic bottles, bags, and microplastics), fishing and marine gear (e.g., ghost nets, fishing lines, and buoys), metals and glass (e.g., aluminum cans, glass jars, and scrap metal), rubber and automotive waste (e.g., tires, oil residue, and hoses), hygiene and medical waste (e.g., wet wipes, syringes, and diapers), biological and vegetative overgrowth (e.g., harmful algae blooms, excessive native or invasive seaweed, and invasive plant growth), and general refuse and other items (e.g., cigarette butts, clothing, and batteries).

As further shown in FIG. 4, process 400 may include receiving a capability parameter associated with the cleaning robot (block 406). In some embodiments, the processor 310 may receive, from the internal sensors 330, various metrics related to the operability of the cleaning robot 100. For example, the processor 310 may identify the relevant internal information of the cleaning robot such as, but not limited to, remaining battery, current power drain, propulsion status, accessory status, battery temperature, processor temperature, water intake, or any appropriate internal information associated with the cleaning robot 100.

As also shown in FIG. 4, process 400 may include generating a plan for the cleaning robot to collect and dispose of the debris based on the capability parameter, the debris position, and the debris type (block 408). For example, the processor 310 may utilize the pathing neural model of the machine learning model 320 to generate a list of commands for the cleaning robot 100 to execute to accomplish the goal of collecting debris as efficiently as the hardware of the cleaning robot 100 would allow.

In some embodiments, the plan may be transmitted to the client computing device 375 for review by the user, via the network 360. In some embodiments, the plan may be altered by the user to prioritize the clean-up of specific debris, specific locations, and any other parameter related to the plan. In some embodiments, the plan is updated based on the feedback from the user.

As further shown in FIG. 4, process 400 may include executing the plan by the cleaning robot (block 410). For example, the processor 310 may transmit to the navigation 340 instructions to begin moving the cleaning robot 100 in line with the path laid out in the plan generated by the pathing neural model and activate the accessory when the cleaning robot 100 is in the debris cleaning locations and the debris is within range of the accessory.

As also shown in FIG. 4, process 400 may include receiving, during the execution of the plan, an updated surrounding environment status (block 412). For example, the processor 310 may, in real-time, receive information from the exterior sensors 335 as the cleaning robot 100 is executing the plan.

As further shown in FIG. 4, process 400 may include determining, based on the updated surrounding environment status and the plan, a progress status (block 414). For example, the updated information may be received by the machine learning model 320, which may determine the progress of the plan based on the progress of the execution, any changes to the environment, the rate at which the cleaning robot 100 is consuming power, the rate at which the accessory is cleaning the debris, input from a user, and any other information relevant to the progress of the cleaning robot 100.

As also shown in FIG. 4, process 400 may include determining, based on the progress status, an updated plan which increases the likelihood of success for collecting and disposing of the debris (block 416). For example, the processor 310 may receive from the machine learning model 320 an updated plan for the remaining cleaning operations, which increases the chances of successfully cleaning the peak amount of debris possible, considering the limitations of the cleaning robot 100 and the external environment of the cleaning robot 100.

As further shown in FIG. 4, process 400 may include executing, by the cleaning robot, the updated plan (block 418). For example, the processor 310 may send commands to the navigation 340 and the modular attachment interface 345 to conduct operations in line with the updated plan.

In some embodiments, the plan for the cleaning robot 100 to collect and dispose of the debris requires an alternative tool attachment. In similar circumstances, the process 400 may further include navigating to a base station (e.g., auto trailer 200) and installing the alternative tool attachment via the modular attachment interface 345. For instance, when the cleaning robot 100 identifies a large amount of invasive vegetation, a trimmer attachment may be required for efficient removal; however, this operation is highly battery-intensive, and thus may only be executed when the battery level is high or a charger is immediately available. Conversely, when the cleaning robot 100 identifies an oil slick, a sprayer attachment for applying an oil-dispersing agent may be prioritized, but this option would be quickly dismissed if highly windy conditions are present, as the strong winds would significantly reduce the sprayer's effectiveness by causing excessive drift of the agent being sprayed. The decision to swap attachments may be dynamically determined by factors like the type and amount of debris, weather conditions, and the robot's resource constraints (e.g., battery level, charger/accessory availability, and the like).

In some embodiments, the cleaning robot 100 may receive a second capability parameter from a second cleaning robot. In similar circumstances, the process 400 may further include generating a first plan for the cleaning robot and a second plan for the second cleaning robot to collect and dispose of the debris based on the capability parameter, the second capability parameter, the debris position, and the debris type. In some embodiments, the process 400 may further comprise executing the first plan by the cleaning robot and the second plan by the second cleaning robot.

In some embodiments, the process 400 may further include the plan having a first cleaning operation on a first terrain and a second cleaning operation on a second terrain. For instance, the cleaning robot 100 may execute the first operation on a submerged area dense with rooted aquatic plants using the trimmer attachment to cut away and harvest the vegetation. The plan may also include a second operation on an adjacent sandy beach where the cleaning robot 100 may transition to using surface collection accessories (e.g., specialized rakes or fine mesh nets) that skim the surface of the sand to efficiently remove light, deposited debris such as dried seaweed or plastic fragments. In some embodiments, this may require the system to dynamically adapt its locomotion, cleaning accessory, and path planning strategy for optimal efficiency.

In some embodiments, the process 400 may further include the external sensor comprises at least one of a lidar, sonar, Doppler, GPS, compass, depth sensor, pressure sensor, and camera. In some embodiments, the internal sensors 330 and external sensors 335 may provide the comprehensive environmental data required for autonomous operation. For example, a Doppler sensor may be used to measure the speed of the cleaning robot 100 and direction relative to the water current to correct for drift, while a high-resolution Lidar unit may be employed during land or beach operations to build a precise elevation map for obstacle avoidance. Simultaneously, a pressure sensor and depth sensor may ensure the cleaning robot 100 maintains a safe operational depth while the sonar actively maps the underwater terrain and debris fields.

In some embodiments, the process 400 may further include the cleaning robot maneuvering via at least two Archimedes screws. In some embodiments, the cleaning robot 100 may be may be provided with an amphibious locomotion system comprising two parallel Archimedes screws positioned longitudinally on the underside of the cleaning robot 100. In some embodiments, the pair of Archimedes screws may be independently actuated and configured to provide thrust and maneuverability across diverse environments. In some embodiments, for operation on water, the Archimedes screws may be rotated to generate forward thrust, enabling efficient and stable movement in the direction of the cleaning robot 100's primary axis. Conversely, when maneuvering on land, including beaches and mixed terrain, the unique helical geometry of the screws can be utilized to generate lateral forces. By rotating the two parallel screws in specific differential or synchronized manners, the cleaning robot 100 may be propelled in a sideways (i.e., crab walk) direction perpendicular to its primary axis, thereby facilitating high-precision positioning, obstacle avoidance, and simplified shoreline transitions without the need for complex wheel steering or reorientation mechanisms.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

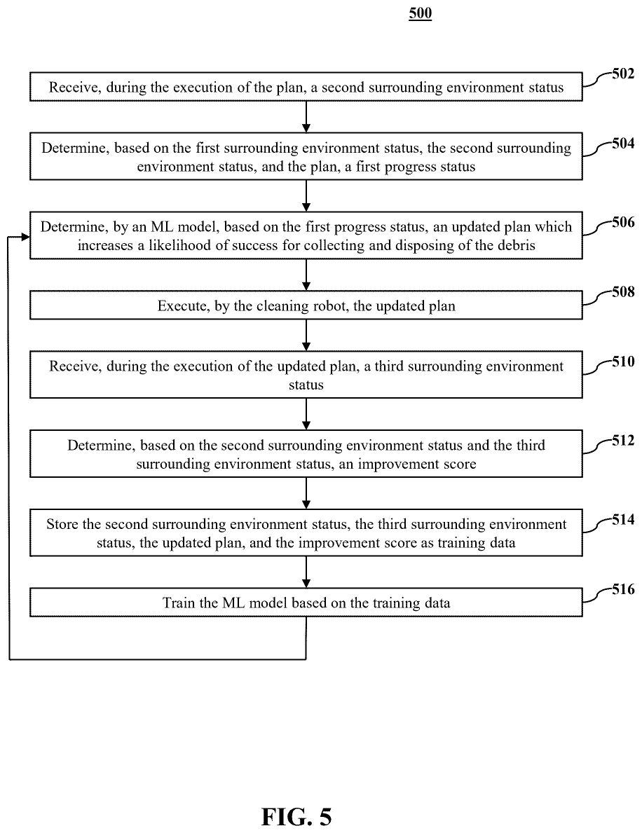

FIG. 5 is a flowchart of an example process 500 for refining the machine learning model 320 through operations of the cleaning robot 100. In some implementations, one or more process blocks of FIG. 5 may be performed by a processor 310. Process 500 may include additional implementations, such as any single implementation or any combination of implementations described below and/or in connection with one or more other processes described elsewhere herein.

As shown in FIG. 5, process 500 may include receiving, during the execution of the plan, a second surrounding environment status (block 502). For example, the second status may provide a mid-mission update, such as a Doppler sensor indicating a rapid change in water current velocity or the Lidar detecting a newly fallen tree blocking the planned path on the beach.

As shown in FIG. 5, process 500 may include determining, based on the first surrounding environment status, the second surrounding environment status, and the plan, a first progress status (block 504). For example, the progress status may be quantified as the percentage of the planned cleaning area covered using GPS and sonar mapping data, or as the estimated time remaining until the next required battery recharge, calculated by correlating the robot's current power draw with the remaining battery capacity. For instance, when the plan requires the robot to clean 500 m² of seabed and the sonar map indicates 250 m² have been successfully vacuumed, the progress status is 50% complete for the area coverage goal.

As shown in FIG. 5, process 500 may include determining, by an ML model, based on the first progress status, an updated plan which increases a likelihood of success for collecting and disposing of the debris (block 506). For example, when the initial plan involved using only surface skimming and the progress status indicates a low collection rate due to excessive water turbulence or the presence of large, rigid plastic debris, the machine learning model 320 may update the plan to include a path to the base station to swap the skimmer accessory for a mechanical gripper accessory. Alternatively, when the progress status reports rapid battery depletion during an aggressive trim operation, the machine learning model 320 may reduce the trimmer's power setting and replan the remaining cleaning area using a more energy-conservative path to ensure completion before the battery runs out.

As shown in FIG. 5, process 500 may include executing, by the cleaning robot, the updated plan (block 508). For example, execution may involve the cleaning robot 100 following a recalculated path that prioritizes the nearest obstacle-free route to the auto trailer 200 after a low battery alert is received. Alternatively, the execution may involve the cleaning robot 100 immediately diverting from a collection sweep to activate a sprayer attachment in a newly detected localized oil spill zone as identified in the second surrounding environment status, before resuming the original cleaning pattern.

As shown in FIG. 5, process 500 may include receiving, during the execution of the updated plan, a third surrounding environment status (block 510). In some embodiments, the third surrounding environment status allows the cleaning robot 100 to detect and respond to unforeseen changes that may occur after the updated plan was finalized, such as a sudden severe drop in battery voltage indicating a system fault, or the appearance of a new, floating obstacle like a log or boat. The continuous receipt of environment status ensures the cleaning robot 100 may perform real-time error checking and re-evaluate its ongoing operational safety and efficiency.

As shown in FIG. 5, process 500 may include determining, based on the second surrounding environment status and the third surrounding environment status, an improvement score (block 512). In some embodiments, the improvement score may be calculated by quantifying the reduction in debris density (e.g., kilograms of plastic removed per cubic meter of water) measured by the exterior sensors 335 between the second status and the third status, and may be further refined by factoring in the energy cost of the cleaning operation. For example, a high improvement score may be assigned when a significant volume of microplastics is removed from a target area with minimal battery expenditure (as compared to the expected battery expenditure), thus providing a metric for the cleaning robot's mission effectiveness and efficiency.

As shown in FIG. 5, process 500 may include storing the second surrounding environment status, the third surrounding environment status, the updated plan, and the improvement score as training data (block 514). In some embodiments, the collected training data may be used to refine and improve the performance of the machine learning model 320 (e.g., the neural network used for path planning or the object detection model). For instance, an environment status that shows the cleaning robot 100 successfully cleaned a large patch of plastic debris using a low-battery path and received a high improvement score may be used as a positive training example to optimize the model's future decision-making under similar low-resource conditions.

As shown in FIG. 5, process 500 may include training the ML model based on the training data (block 516). In some embodiments, this iterative training process may involve refining the weights and biases of the neural network that comprises the machine learning model 320 using techniques like backpropagation and stochastic gradient descent. For instance, the machine learning model 320 may be updated to increase the value (reward) of using the surface collection accessories when the training data indicates that this combination resulted in a high debris removal rate on sandy terrain with moderate wave action. Furthermore, the machine learning model 320 may learn to assign a high-cost penalty to a plan that suggests using the battery-intensive trimmer when the robot's current battery status is below a certain minimum threshold, reflecting past mission failures due to premature power depletion.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

### EXAMPLE CLAUSES

Example Clause A: A method for operating a cleaning robot in and around a body of water, may include: receiving, via an external sensor, a first surrounding environment status; identifying, based on the first surrounding environment status, a debris, and based on the debris, identifying a debris position and a debris type; receiving a capability parameter associated with the cleaning robot; generating a plan for the cleaning robot to collect and dispose of the debris based on the capability parameter, the debris position, and the debris type; and executing the plan by the cleaning robot.

Example Clause B: The method of Example Clause A, further may include: receiving, during the execution of the plan, a second surrounding environment status; determining, based on the first surrounding environment status, the second surrounding environment status, and the plan, a first progress status; determining, by an ML model, based on the first progress status, an updated plan which increases a likelihood of success for collecting and disposing of the debris; and executing, by the cleaning robot, the updated plan.

Example Clause C: The method of Example Clause A or Example Clause B, further may include: receiving, during the execution of the updated plan, a third surrounding environment status; determining, based on the second surrounding environment status and the third surrounding environment status, an improvement score; storing the second surrounding environment status, the third surrounding environment status, the updated plan, and the improvement score as training data; and training the ML model based on the training data.

Example Clause D: The method of any one of Example Clauses A-C, where the plan for the cleaning robot to collect and dispose of the debris requires an alternative tool attachment and further may include: navigating to a base station and installing the alternative tool attachment; and executing the plan by the cleaning robot with the alternative tool attachment.

Example Clause E: The method of any one of Example Clauses A-D, where the cleaning robot receives a second capability parameter from a second cleaning robot, and the method further may include: generating a first plan for the cleaning robot and a second plan for the second cleaning robot to collect and dispose of the debris based on the capability parameter, the second capability parameter, the debris position, and the debris type; and executing the first plan by the cleaning robot and the second plan by the second cleaning robot.

Example Clause F: The method of any one of Example Clauses A-E, where the plan includes a first cleaning operation on a first terrain and a second cleaning operation on a second terrain.

Example Clause G: The method of any one of Example Clauses A-F, where the external sensor may include at least one of a lidar, sonar, Doppler, GPS, compass, depth sensor, pressure sensor, and camera.

Example Clause H: The method of any one of Example Clauses A-G, where the cleaning robot maneuvers via at least two Archimedes screws.

Example Clause I: A device for cleaning in and around a body of water may include: one or more processors configured to: receive, via an external sensor of a cleaning robot, a first surrounding environment status; identify, based on the first surrounding environment status, a debris, and based on the debris, identify a debris position and a debris type; receive a capability parameter associated with the cleaning robot; generate a plan for the cleaning robot to collect and dispose of the debris based on the capability parameter, the debris position, and the debris type; and execute the plan by the cleaning robot.

Example Clause J: The device of Example Clause I, where the one or more processors are further configured to: receive, during the execution of the plan, a second surrounding environment status; determine, based on the first surrounding environment status, the second surrounding environment status, and the plan, a first progress status; determine, by an ML model, based on the first progress status, an updated plan which increases a likelihood of success for collecting and disposing of the debris; and execute, by the cleaning robot, the updated plan.

Example Clause K: The device of Example Clause I or Example Clause J, where the one or more processors are further configured to: receive, during the execution of the updated plan, a third surrounding environment status; determine, based on the second surrounding environment status and the third surrounding environment status, an improvement score; store the second surrounding environment status, the third surrounding environment status, the updated plan, and the improvement score as training data; and train the ML model based on the training data.

Example Clause L: The device of any one of Example Clauses I-K, where the one or more processors, when the plan for the cleaning robot to collect and dispose of the debris requires an alternative tool attachment and, are configured to: navigate to a base station and install the alternative tool attachment; and execute the plan by the cleaning robot with the alternative tool attachment.

Example Clause M: The device of any one of Example Clauses I-L, where the one or more processors, when the cleaning robot receives a second capability parameter from a second cleaning robot, and the method, are configured to: generate a first plan for the cleaning robot and a second plan for the second cleaning robot to collect and dispose of the debris based on the capability parameter, the second capability parameter, the debris position, and the debris type; and execute the first plan by the cleaning robot and the second plan by the second cleaning robot.

Example Clause N: The device of any one of Example Clauses I-M, where the plan includes a first cleaning operation on a first terrain and a second cleaning operation on a second terrain.

Example Clause O: A system for operating a cleaning robot in and around a body of water may include: one or more processors configured to: receive, via an external sensor, a first surrounding environment status; identify, based on the first surrounding environment status, a debris, and based on the debris, identify a debris position and a debris type; receive a capability parameter associated with the cleaning robot; generate a plan for the cleaning robot to collect and dispose of the debris based on the capability parameter, the debris position, and the debris type; and execute the plan by the cleaning robot.

Example Clause P: The system of Example Clause O, where the one or more processors are further configured to: receive, during the execution of the plan, a second surrounding environment status; determine, based on the first surrounding environment status, the second surrounding environment status, and the plan, a first progress status; determine, by an ML model, based on the first progress status, an updated plan which increases a likelihood of success for collecting and disposing of the debris; and execute, by the cleaning robot, the updated plan.

Example Clause Q: The system of Example Clause O or Example Clause P, where the one or more processors are further configured to: receive, during the execution of the updated plan, a third surrounding environment status; determine, based on the second surrounding environment status and the third surrounding environment status, an improvement score; store the second surrounding environment status, the third surrounding environment status, the updated plan, and the improvement score as training data; and train the ML model based on the training data.

Example Clause R: The system of any one of Example Clauses O-Q, where the one or more processors, when the plan for the cleaning robot to collect and dispose of the debris requires an alternative tool attachment and, are configured to: navigate to a base station and install the alternative tool attachment; and execute the plan by the cleaning robot with the alternative tool attachment.

Example Clause S: The system of any one of Example Clauses O-R, where the one or more processors, when the cleaning robot receives a second capability parameter from a second cleaning robot, and the method, are configured to: generate a first plan for the cleaning robot and a second plan for the second cleaning robot to collect and dispose of the debris based on the capability parameter, the second capability parameter, the debris position, and the debris type; and execute the first plan by the cleaning robot and the second plan by the second cleaning robot.

Example Clause T: The system of any one of Example Clauses O-S, where the cleaning robot maneuvers via at least two Archimedes screws.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A method for operating a cleaning robot in and around a body of water, comprising:
receiving, via an external sensor, a first surrounding environment status;
identifying, based on the first surrounding environment status, a debris, and based on the debris, identifying a debris position and a debris type;
receiving a capability parameter associated with the cleaning robot;
generating a plan for the cleaning robot to collect and dispose of the debris based on the capability parameter, the debris position, and the debris type; and
executing the plan by the cleaning robot.

2. The method of claim 1, further comprising:
receiving, during the execution of the plan, a second surrounding environment status;
determining, based on the first surrounding environment status, the second surrounding environment status, and the plan, a first progress status;
determining, by an ML model, based on the first progress status, an updated plan which increases a likelihood of success for collecting and disposing of the debris; and
executing, by the cleaning robot, the updated plan.

3. The method of claim 2, further comprising:
receiving, during the execution of the updated plan, a third surrounding environment status;
determining, based on the second surrounding environment status and the third surrounding environment status, an improvement score;
storing the second surrounding environment status, the third surrounding environment status, the updated plan, and the improvement score as training data; and
training the ML model based on the training data.

4. The method of claim 1, wherein the plan for the cleaning robot to collect and dispose of the debris requires an alternative tool attachment and further comprises:
navigating to a base station and installing the alternative tool attachment; and
executing the plan by the cleaning robot with the alternative tool attachment.

5. The method of claim 1, wherein the cleaning robot receives a second capability parameter from a second cleaning robot, and the method further comprises:
generating a first plan for the cleaning robot and a second plan for the second cleaning robot to collect and dispose of the debris based on the capability parameter, the second capability parameter, the debris position, and the debris type; and
executing the first plan by the cleaning robot and the second plan by the second cleaning robot.

6. The method of claim 1, wherein the plan includes a first cleaning operation on a first terrain and a second cleaning operation on a second terrain.

7. The method of claim 1, wherein the external sensor comprises at least one of a lidar, sonar, Doppler, GPS, compass, depth sensor, pressure sensor, and camera.

8. The method of claim 1, wherein the cleaning robot maneuvers via at least two Archimedes screws.

9. A device for cleaning in and around a body of water comprising:
one or more processors configured to:
receive, via an external sensor of a cleaning robot, a first surrounding environment status;
identify, based on the first surrounding environment status, a debris, and based on the debris, identify a debris position and a debris type;
receive a capability parameter associated with the cleaning robot;
generate a plan for the cleaning robot to collect and dispose of the debris based on the capability parameter, the debris position, and the debris type; and
execute the plan by the cleaning robot.

10. The device of claim 9, wherein the one or more processors are further configured to:
receive, during the execution of the plan, a second surrounding environment status;
determine, based on the first surrounding environment status, the second surrounding environment status, and the plan, a first progress status;
determine, by an ML model, based on the first progress status, an updated plan which increases a likelihood of success for collecting and disposing of the debris; and
execute, by the cleaning robot, the updated plan.

11. The device of claim 10, wherein the one or more processors are further configured to:
receive, during the execution of the updated plan, a third surrounding environment status;
determine, based on the second surrounding environment status and the third surrounding environment status, an improvement score;
store the second surrounding environment status, the third surrounding environment status, the updated plan, and the improvement score as training data; and
train the ML model based on the training data.

12. The device of claim 9, wherein the one or more processors, when the plan for the cleaning robot to collect and dispose of the debris requires an alternative tool attachment and, are configured to:
navigate to a base station and install the alternative tool attachment; and
execute the plan by the cleaning robot with the alternative tool attachment.

13. The device of claim 9, wherein the one or more processors, when the cleaning robot receives a second capability parameter from a second cleaning robot, and the method, are configured to:
generate a first plan for the cleaning robot and a second plan for the second cleaning robot to collect and dispose of the debris based on the capability parameter, the second capability parameter, the debris position, and the debris type; and
execute the first plan by the cleaning robot and the second plan by the second cleaning robot.

14. The device of claim 9, wherein the plan includes a first cleaning operation on a first terrain and a second cleaning operation on a second terrain.

15. A system for operating a cleaning robot in and around a body of water comprising:
one or more processors configured to:
receive, via an external sensor, a first surrounding environment status;
identify, based on the first surrounding environment status, a debris, and based on the debris, identify a debris position and a debris type;
receive a capability parameter associated with the cleaning robot;
generate a plan for the cleaning robot to collect and dispose of the debris based on the capability parameter, the debris position, and the debris type; and
execute the plan by the cleaning robot.

16. The system of claim 15, wherein the one or more processors are further configured to:
receive, during the execution of the plan, a second surrounding environment status;
determine, based on the first surrounding environment status, the second surrounding environment status, and the plan, a first progress status;
determine, by an ML model, based on the first progress status, an updated plan which increases a likelihood of success for collecting and disposing of the debris; and
execute, by the cleaning robot, the updated plan.

17. The system of claim 16, wherein the one or more processors are further configured to:
receive, during the execution of the updated plan, a third surrounding environment status;
determine, based on the second surrounding environment status and the third surrounding environment status, an improvement score;
store the second surrounding environment status, the third surrounding environment status, the updated plan, and the improvement score as training data; and
train the ML model based on the training data.

18. The system of claim 15, wherein the one or more processors, when the plan for the cleaning robot to collect and dispose of the debris requires an alternative tool attachment and, are configured to:
navigate to a base station and install the alternative tool attachment; and
execute the plan by the cleaning robot with the alternative tool attachment.

19. The system of claim 15, wherein the one or more processors, when the cleaning robot receives a second capability parameter from a second cleaning robot, and the method, are configured to:
generate a first plan for the cleaning robot and a second plan for the second cleaning robot to collect and dispose of the debris based on the capability parameter, the second capability parameter, the debris position, and the debris type; and
execute the first plan by the cleaning robot and the second plan by the second cleaning robot.

20. The system of claim 15, wherein the cleaning robot maneuvers via at least two Archimedes screws.
